(19) United States
(12) Patent Application Publication
(10) Pub. No.: US 2026/0349590 A1
(43) Pub. Date: Nov. 5, 2026

(54) METHOD, APPARATUS, DEVICE AND STORAGE MEDIUM FOR GESTURE EVENT PROCESSING

(71) Applicant: Beijing Zitiao Network Technology Co., Ltd., Beijing (CN)

(72) Inventors: Aoyu Wang, Beijing (CN); Yi Chen, Beijing (CN)

(21) Appl. No.: 19/102,747

(22) PCT Filed: Aug. 5, 2023
(86) PCT No.: PCT/CN2023/111355

§ 371 Date: Feb. 10, 2025

(30) Foreign Application Priority Data
Aug. 10, 2022 (CN) 202210955382.8

(51) Int. Cl. G06F 3/04842; G06F 3/01; G06F 3/04815; G06F 3/04847

(52) U.S. Cl. CPC G06F 3/04842; G06F 3/017; G06F 3/04815; G06F 3/04847

(57) ABSTRACT

The method for gesture event processing includes detecting a predetermined gesture event-) for a presented scene. The scene includes a UI element and an object of a different type than the UI element. The method further includes selecting an interaction target from the at least one UI element and the at least one object in response to determining that the predetermined gesture event involves the at least one UI element and at least one object. The method also includes causing the selected interaction target to respond to the predetermined gesture event without the rest of the at least one UI element and the at least one object except the interaction target responding to the predetermined gesture event. Therefore, in a scenario in which a UI element and another type of object coexist, an interaction target for a gesture event may be determined, thereby avoiding potential interaction confusion.

This application claims the benefit of Chinese Application No. 202210955382.8, entitled “METHOD, APPARATUS, DEVICE, AND STORAGE MEDIUM FOR GESTURE EVENT PROCESSING,” filed on Aug. 10, 2022, the entirety of which is incorporated herein by reference.

### FIELD

Example embodiments of the present disclosure generally relate to the field of computers, and in particular, to a method, apparatus, device and computer-readable storage medium for gesture event processing.

### BACKGROUND

Currently, gestures have been widely used for human-machine interaction. On the other hand, an increasing number of hardware and applications are designed to present various scenes to users. For example, some hardware and applications may present virtual reality (VR) or augmented reality (AR) scenes to game players to provide an immersive experience. Such scenes typically include user interface (UI) elements and objects of different types than the UI elements, such as AR objects in AR scenes. Users may interact with UI elements and objects in the scenes through gestures.

### SUMMARY

In a first aspect of the present disclosure, a method for gesture event processing is provided. In the method, a predetermined gesture event for a presented scene is detected. The scene includes a UI element and an object of a different type than the UI element. In response to determining that the predetermined gesture event involves at least one UI element and at least one object, an interaction target is selected from the at least one UI element and the at least one object. The selected interaction target is caused to respond to the predetermined gesture event without the rest of the at least one UI element and the at least one object except the interaction target responding to the predetermined gesture event.

In a second aspect of the present disclosure, an apparatus for gesture event processing is provided. The apparatus comprises a gesture detection module, a target selection module and a gesture response module. The gesture detection module is configured to detect a predetermined gesture event for a presented scene. The scene includes a UI element and an object of a different type than the UI element. The target selection module is configured to select an interaction target from the at least one UI element and at least one object in response to determining that the predetermined gesture event involves the at least one UI element and the at least one object. The gesture response module is configured to cause the interaction target to respond to the predetermined gesture event without the rest of the at least one UI element and the at least one object except the interaction target responding to the predetermined gesture event.

In a third aspect of the present disclosure, an electronic device is provided. The device includes at least one processing unit and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer readable storage medium stores a computer program, and the computer program is executable by a processor to implement the method according to the first aspect.

It should be understood that content described in this summary section is not intended to limit key features or important features of embodiments of the present disclosure, nor is it intended to limit the scope of the present disclosure. Other features of the present disclosure will be readily understood from the following description.

### BRIEF DESCRIPTION OF THE DRAWINGS

The above and other features, advantages and aspects of embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a schematic diagram of a system architecture of an engine according to some embodiments of the present disclosure;

FIG. 3A illustrates a state machine of a continuous gesture according to some embodiments of the present disclosure;

FIG. 3B illustrates a state machine of a discrete gesture according to some embodiments of the present disclosure;

FIG. 4 illustrates a flowchart of a process of gesture event processing according to some embodiments of the present disclosure;

FIG. 5 illustrates a schematic diagram of a gesture event for a scene according to some embodiments of the present disclosure;

FIG. 6 illustrates a schematic diagram of a subsequent gesture event for a scene according to some embodiments of the present disclosure;

FIG. 7 illustrates a block diagram of an apparatus for gesture event processing according to some embodiments of the present disclosure; and

FIG. 8 illustrates a block diagram of a device capable of implementing various embodiments of the present disclosure.

### DETAILED DESCRIPTION

Embodiments of the present disclosure will be described in more detail below with reference to the accompanying drawings. Although certain embodiments of the disclosure are illustrated in the drawings, it would be appreciated that the disclosure may be embodied in various forms and should not be construed as limited to the embodiments set forth herein. These embodiments are provided to provide a more thorough and complete understanding of the disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising” and similar terms thereof should be understood as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

As mentioned above, gestures have been widely used for human-machine interaction. A gesture system may be included in an input module of a mobile device, for example, a touch gesture in an iOS system or an Android system. Touch panels of notebook computers may also provide rich gesture operations. Such touch gestures include, for example, two-finger zoom, rotation, one-finger swipe, etc. On the other hand, in an operating system, determining a clicked UI element and triggering a corresponding function may be regarded as a response. In a three-dimensional (3D) scene such as a game, selecting a 3D object and manipulating the selected 3D object is also a response.

In the scenes that include UI elements and objects of different types than the UI elements, UI elements and those objects may be presented in a more complex manner. For example, VR scenes typically include UI elements and VR objects, and the UI elements may overlap with some VR objects from a viewer's perspective. Thus, in such a scene, a gesture event initiated by a user may involve different types of interaction objects including UI elements. This requires the joint use of the UI response and object response to process the gesture event for such scene.

Embodiments of the present disclosure provide a solution for gesture event processing. According to various embodiments of the present disclosure, when a gesture event is detected, it is determined whether the gesture event hits at least one UI element and at least one object. If at least one UI element and at least one object are hit, an interaction target of the gesture event is selected from the hit UI element(s) and object(s). The selected interaction target is caused to respond to the gesture event and unselected item(s) is(are) prevented from responding to the gesture event. In this way, in a scene in which a UI element and an object of a different type are present, an interaction target of a gesture event may be specified, thereby avoiding potential interaction confusion.

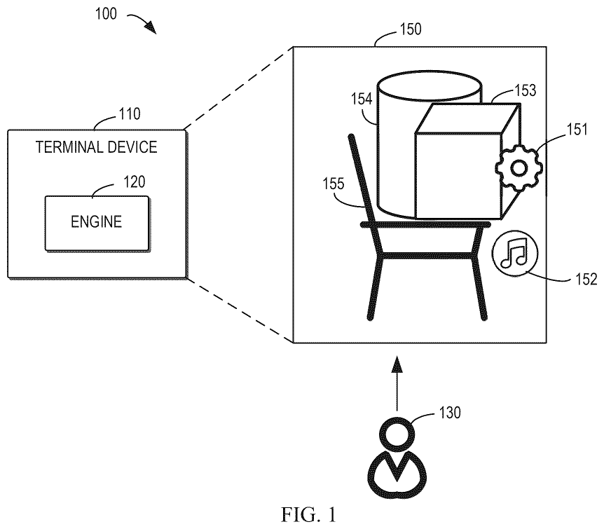

FIG. 1 illustrates a schematic diagram of an example environment 100 in which embodiments of the present disclosure may be implemented. The terminal device 110 may be any type of mobile terminal, fixed terminal, or portable terminal, including a mobile phone, desktop computer, laptop computer, notebook computer, netbook computer, tablet computer, media computer, multimedia tablet, gaming device, wearable device, personal communication system (PCS) device, personal navigation device, personal digital assistant (PDA), audio/video player, digital camera/camcorder, positioning device, television receiver, radio broadcast receiver, electronic book device, or any combination of the foregoing, including accessories and peripherals of these devices, or any combination thereof.

A scene 150 is presented to a user 130 at or by the terminal device 110. The scene 150 includes UI elements 151, 152 and objects 153, 154, and 155, and the objects 153, 154, and 155 are of different types than the UI elements. The user 130 may interact with at least some of UI elements 151, 152 and objects 153, 154, and 155 through predetermined gestures. Hereinafter, the UI elements 151, 152 and objects 153, 154, 155 are collectively or individually referred to as interaction items for discussion purposes only.

In the example of FIG. 1, the scene 150 is an AR scene. The UI element 151 is a settings control for setting a parameter of aspects of the scene 150. The UI element 152 is a music control for controlling playing of music in the scene 150. The user 130 may set the scene 150 and control the music playback through the UI elements 151 and 152, and thus the UI elements 151 and 152 are interactive.

The object 155 is a representation of a real object in the real world, in this example a chair, in the scene 150, such as an image or other forms of representation of the real object. The object 155 is also referred to herein as a 3D object for ease of discussion only. In some embodiments, the object 155 is interactive. For example, the size, orientation, display pixels, etc. of the object 155 may change in response to an input of the user 130.

The objects 153 and 154 are virtual objects, and specifically are AR objects in this example. The objects 153 and 154 are used to represent a cylinder and a cube, respectively, placed on the chair. The objects 153 and 154 are interactive, e.g., the size, orientation, color, etc. of the objects 153 and 154 may change in response to an input of the user 130.

In the example environment 100, the UI element 151 partially overlaps the object 153 and the object 153 partially overlaps the object 154 from the perspective of the user 130 (i.e., viewer). It should be understood that the scene 150 is merely exemplary and is not intended to limit the scope of the present disclosure. The scene 150 may include more or fewer UI elements and objects.

An engine 120 is installed in the terminal device 110. The engine 120 is configured to drive the presentation of the scene 150. In some examples, the engine 120 may be an AR game engine, and accordingly, the scene 150 may be an AR game scene.

It should be understood that the structure and functions of the environment 100 are described for exemplary purposes only and do not imply any limitation on the scope of the present disclosure. The terminal device 110 may include any suitable structure and function to implement gesture event processing according to the embodiments of the present disclosure.

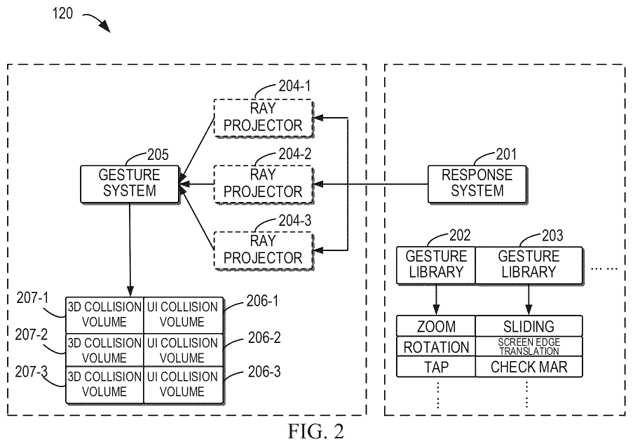

FIG. 2 illustrates a schematic diagram of a system architecture of the engine 120 according to some embodiments of the present disclosure. A gesture system 205 in the engine 120 collects and manages collision volumes of the objects in the scene 150. The collision volumes define boundaries of respective objects in the scene 150. For example, 3D collision volumes 207-1, 207-2, 207-3 define boundaries of 3D objects (such as the object 155) and virtual objects (such as the objects 153, 154) in the scene 150. Hereinafter, the 3D collision volumes 207-1, 207-2, 207-3 are collectively referred to as 3D collision volumes 207. UI collision volumes 206-1, 206-2, 206-3 define boundaries of UI elements, such as the UI elements 151, 152, in the scene 150. Hereinafter, the UI collision volumes 206-1, 206-2, 206-3 are collectively referred to as UI collision volumes 206.

The number of collision volumes in the engine 120 changes dynamically as the scene 150 changes. If a new UI element or object is presented in the scene 150, a corresponding collision volume is added in the engine 120, and the gesture system 205 may collect and manage the added collision volume. If a UI element or object is no longer presented, the corresponding collision volume is removed from the engine 120.

A response system 201 is configured to determine which interaction item or items in the scene 150 are hit by a predetermined gesture event for the scene 150. In other words, the response system 201 is configured to determine interaction item(s) involved by the gesture event.

In some embodiments, the response system 201 may rank the involved interaction items. In some examples, the interaction items may be sorted by their depths in the scene 150. As used herein, the term “depth” refers to a distance between an interaction item in the scene 150 and a viewer of the scene 150. In another example, these interaction items may be sorted by type. For example, UI elements may have a higher ranking than objects in the scene 150. In still other examples, the depth and type may be combined. In such embodiments, the top ranked interaction item may be selected as the interaction target.

In some embodiments, the response system 201 may use a ray casting algorithm to determine UI element(s) or object(s) involved by the predetermined gesture event. In such embodiments, the engine 120 may include ray projectors 204-1, 204-2, 204-3 for casting rays, also collectively or individually referred to as ray projectors 204.

In some embodiments, the ray projectors 204 may be associated with different types of virtual cameras configured to monitor the UI elements and objects in the scene 150. For example, the ray projector 204 may be mounted under the different types of virtual cameras. A virtual camera for monitoring the objects in the scene 150 may also be referred to as an object camera. For example, in the AR scene, the object camera may further include an AR camera for monitoring AR objects and a 3D camera for monitoring 3D objects. A virtual camera for monitoring the UI elements in the scene 150 may be referred to as a UI camera. Accordingly, the ray projector 204 mounted by the virtual camera corresponds to a UI element or an object in the scene 150 for determining whether the corresponding UI element or object is hit or selected.

The type of the ray projector 204 may depend on the associated virtual camera. Table 1 lists example attributes and methods of the ray projector 204.

TABLE 1
Example attributes and Methods of the Ray Projector

| Attribute | Method |
|---|---|
| type | Casting Object |
| layer | Casting UI |
| | Casting geometry plane |

The attribute “Type” in Table 1 indicates the type of virtual camera to which the ray projector 204 is associated. For example, a value of “type” being UI indicates that the ray projector 204 is associated with a UI virtual camera, a value of “type” being AR indicates that the ray projector 204 is associated with an AR camera, and so on. The attribute “layer” indicates whether the UI element or object to which the ray projector 204 corresponds is interactive. For example, if the ray projector 204 is associated with a 3D camera for monitoring a 3D object, and the 3D object is not interactive, the value of the “layer” of the ray projector may be 1. The attribute “method” indicates the ray casting algorithm employed by the ray projector 204. The “casting object”, “casting UI”, and “casting geometry plane” define specific algorithms for casting rays to objects, UI elements, and geometry planes, respectively, in the scene 150.

These ray projectors 204 may be collected and managed by the response system 201. For example, if a new UI element or object is presented in the scene 150, a corresponding ray projector is added in the engine 120, and the response system 201 can collect and manage the added ray projector. If a UI element or object is no longer presented, the corresponding ray projector may be removed from the engine 120.

The engine 120 also includes gesture libraries 202, 203, etc. for implementing various gestures. For example, the gesture library 202 may include gestures such as zoom, rotation, and tap, and the gesture library 203 may include gestures such as sliding, screen edge translation, and check mark. It should be understood that these gestures are merely examples and are not intended to limit the scope of the present disclosure. The embodiments of the present disclosure may be used for known gestures or customized gestures.

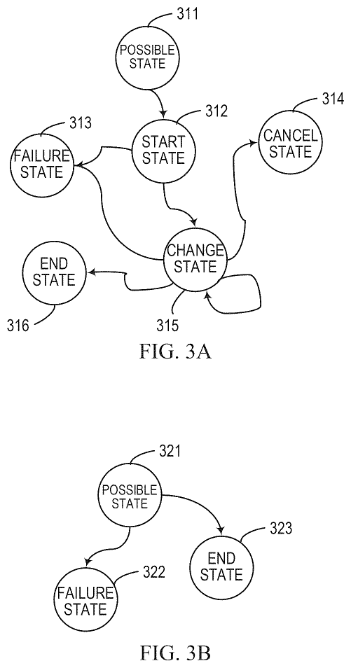

A state machine may be employed for conversion and recognition of gestures. Gestures may be classified into continuous gestures and discrete gestures. The continuous gesture may be continuously triggered, such as a rotation gesture, a zoom gesture, or the like. FIG. 3A illustrates a state machine of a continuous gesture according to some embodiments of the present disclosure. The continuous gesture may include a possible state 311, a start state 312, a failure state 313, a cancel state 314, an end state 316, and a change state 315. The discrete gesture is triggered only once, such as a Tap gesture. FIG. 3B illustrates a state machine of a discrete gesture according to some embodiments of the disclosure. The discrete gesture may include a possible state 321, a failure state 322, and an end state 323. The state of the gesture may be determined from the original touch event (e.g., start, move, end, cancel). When it is determined that the gesture enters into a certain state, a message may be sent to a subscriber of the gesture to complete a corresponding action.

In some embodiments, gestures in the gesture libraries 202 and 203 may be implemented in the form of scripts. This is a lightweight implementation. In this manner, gestures do not depend on the version of compilation and the engine 120, thereby improving flexibility. In some embodiments, the gesture libraries 202 and 203 and the response system 201 may be implemented in a script layer. The gesture system 205, ray projector 204, 3D collision volumes 207, and UI collision volumes 206 may be implemented in a lower layer, such as a code layer.

In some embodiments, the engine 120 may be implemented with an entity-component-system (ECS) architecture. In such embodiments, the gesture system 205 and the response system 201 may be implemented as systems in the ECS architecture, and the 3D collision volumes 207, UI collision volumes 206, and ray projector 204 may be implemented as components in the ECS architecture. With the ECS architecture, the flexibility and scalability of the engine 120 can be improved, thereby facilitating customization and modification of various gestures.

It should be understood that the structure and function of the engine 120 are described for exemplary purposes only and do not imply any limitation on the scope of the present disclosure. The terminal device 120 may include any suitable structure and function to implement gesture event processing according to the embodiments of the present disclosure. In the architecture described in FIG. 2, gestures may be used alone, or responses of different types of interaction items may be used alone. Further, as will be described in detail below, gestures and responses may be used jointly.

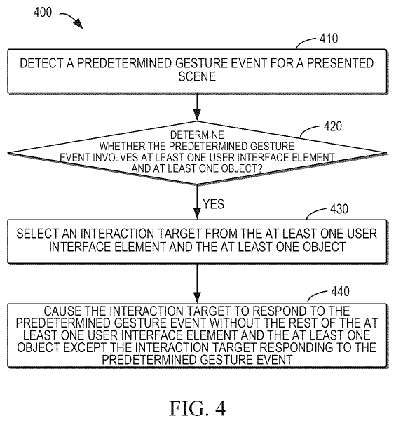

FIG. 4 shows a flowchart of a process 400 of gesture event processing according to embodiments of the present disclosure. The process 400 may be implemented at the terminal device 110. For ease of discussion, the process 400 will be described with reference to the environment 100 of FIG. 1 and the architecture diagram of FIG. 2.

At block 410, the terminal device 110 detects a predetermined gesture event for the presented scene 150. The scene 150 includes the UI elements 151, 152 and objects 153, 154, 155. The predetermined gesture event may be defined by the gesture libraries 202 and 203. In some examples, the scene 150 may be presented on a screen of the terminal device 110. The user 130 may initiate a gesture event 401 by touching the screen. In other examples, the scene 150 may be presented in a real world space. The user 130 may initiate the gesture event 401 by making a gesture in the space.

At block 420, the terminal device 110 determines whether the detected predetermined gesture event involves at least one UI element and at least one object. In other words, the terminal device 110 determines whether the gesture hits at least one UI element and at least one object in the scene 150. As used herein, the term “involve” indicates that the detected gesture hits or selects an interaction item in the scene.

The response system 201 may employ any suitable method to determine which interaction item or items in the scene 150 is or are involved by the gesture event. In some embodiments, a ray casting algorithm may be used to determine the UI element or object involved by the detected gesture event based on a position of the detected gesture event in the scene 150. Specifically, a ray may be emitted from the position of the gesture event in the scene 150. If the emitted ray intersects with an interaction item, it may be determined that the interaction item is hit.

In some embodiments, the response system 201 may traverse all ray projectors 204 corresponding to the UI elements and objects in the scene 150 to determine interaction item(s) involved by the gesture event. As an example, the ray projector 204-1 corresponding to the UI element 151 is associated with, e.g., mounted under, a virtual camera monitoring the UI element 151. The response system 201 may invoke the ray projector 204-1 to determine whether the detected gesture event hits the UI element 151. Similarly, the response system 201 may invoke the ray projector 204-2 associated with a virtual camera monitoring the object 153 to determine whether the gesture event hits the object 153.

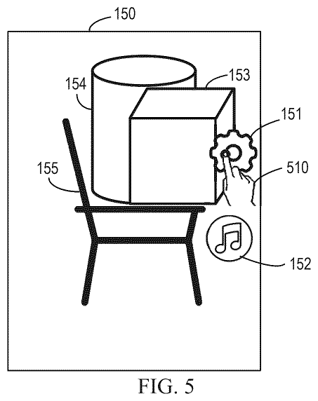

FIG. 5 illustrates a schematic diagram of a gesture event 510 for the scene 150 according to some embodiments of the present disclosure. In the example of FIG. 5, the terminal device 110 may determine that the gesture event 510 hits the UI element 151 and the object 153, that is, the gesture event 510 involves both the UI element 151 and the object 153.

Continued reference is made to FIG. 4. If it is determined at block 420 that the detected predetermined gesture event involves at least one UI element and at least one object, the process 400 proceeds to block 430. At block 430, the terminal device 110 selects an interaction target from the involved at least one UI element and at least one object. In the example of FIG. 5, the terminal device 110 selects an interaction target of the gesture event from the UI element 151 and object 153.

The terminal device 110 may select the interaction target by using any suitable policy. In some embodiments, the interaction target may be selected based on respective depths of interaction items involved in the scene 150. For example, the interaction item with the smallest depth among the involved interaction items may be selected as the interaction target.

In the example of FIG. 5, the terminal device 110 may determine respective depths of the UI element 151 and the object 153 in the scene 150, and select the interaction target based on the determined depths. For example, the UI element 151 with a smaller depth in the UI element 151 and the object 153 may be selected as the interaction target.

In some embodiments, the interaction target may be selected based on the types of involved interaction items. In other words, the interaction priority of the interaction item may depend on the type of the interaction item. For example, the UI element may have the highest priority, that is, the interaction target may be determined from the involved UI elements without considering the involved objects. In these embodiments, other types of responses can be blocked from the UI responses. As such, the functionality of the UI interface can be implemented.

In some embodiments, the interaction target may be selected based on both the depths and types of interaction items. For example, in the case of the 3D UI, some UI elements may have different depths. The UI element with a smaller depth may be selected from the involved UI elements as the interaction target.

In some embodiments, the policy for selecting the interaction target is customizable. For example, the policy may be customized according to the specific application of the engine 120. During development of the engine 120, developers may be notified of the interaction item involved by the gesture event. The notification may include the interaction item being hit, and its type, such as the UI element, 3D object, AR object, or the like. In the embodiments in which the ray projectors 204 are implemented, a message may be sent to the developers. The message may indicate the interaction item being hit, its type, and the corresponding ray projector. In response to receiving the message, the developers may customize a specific policy, such as a depth-based policy, a type-based policy, or a policy based on both the depth and type, etc.

At block 440, the terminal device 110 causes the interaction target to respond to the predetermined gesture event without the rest of the at least one UI element and the at least one object except the interaction target responding to the predetermined gesture event. That is, unselected item(s) of the involved interaction items would not respond to the gesture event.

In some embodiments, if the interaction target is a UI element, the terminal device 110 triggers a function associated with the UI element. In the example of FIG. 5, if the UI element 151 is selected as the interaction target, options related to settings of the scene 150 may be presented. In this case, the object 153 would not respond, that is, the object 153 is not to be manipulated based on the predetermined gesture.

In some embodiments, if the interaction target is an object in the scene 150, the terminal device 110 causes the object to be manipulated in the scene 150 based on the predetermined gesture event. In the example of FIG. 5, if the object 153 is selected as the interaction target, the object 153 may be manipulated according to the gesture event. For example, the gesture event may be a rotation gesture that causes the object 153 to rotate. In this case, the functionality associated with UI element 151 is not to be triggered.

In some embodiments, the joint use of the gestures and responses may be further implemented. Specifically, the terminal device 110 may detect a further gesture event subsequent to the predetermined gesture event for the scene 150, which is also referred to as a “subsequent gesture event”. If the subsequent gesture event involves the at least one UI element and at least one object involved by the previous predetermined gesture event, the previously determined interaction target is caused to respond to the subsequent gesture event.

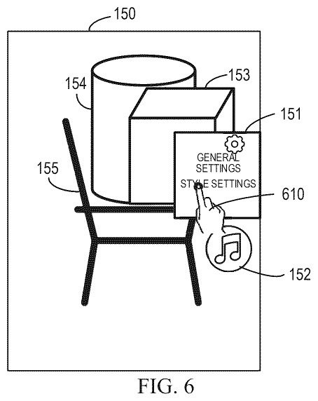

In the example of FIG. 5, the UI element 151 is selected as the interaction target for the predetermined gesture event, and a settings option for the scene 150 is presented. FIG. 6 illustrates a schematic diagram of a subsequent gesture event 610 for the scene 150 according to some embodiments of the present disclosure. As shown in FIG. 6, in response to the gesture event 510, the UI element 151 is selected as the interaction object, and a setting option such as “general settings”, “style settings” and the like is presented. The subsequent gesture event 610 still involves the UI element 151 and object 153. In this case, the terminal device 110 triggers a function associated with the UI element 151, such as presenting a related option of “style settings”. The object 153 is still not to be manipulated.

Reference is back to block 420. If it is determined at block 420 that the predetermined gesture event involves a plurality of objects in the scene 150 and does not involve any UI element, an interaction target may be selected from the objects according to their depths or other attributes in the scene 150. If it is determined at block 420 that the predetermined gesture event involves the UI elements instead of objects in the scene 150, an interaction target may be selected from the UI elements according to their depths or other attributes in the scene 150.

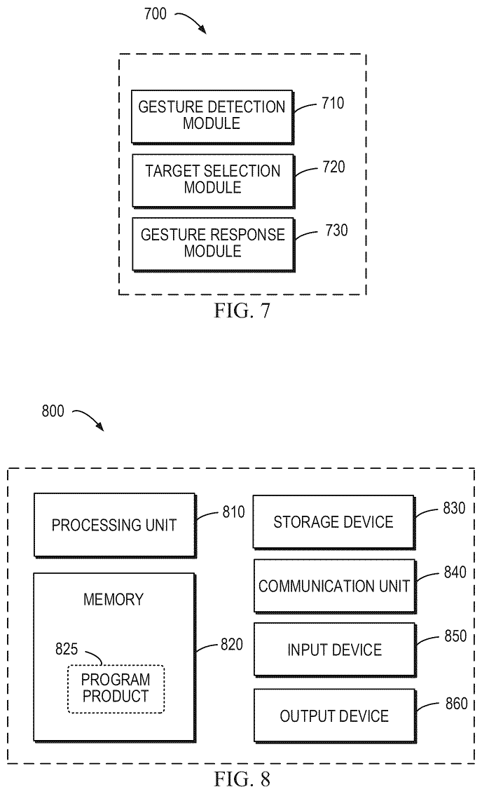

FIG. 7 illustrates a schematic structural block diagram of an apparatus 700 for gesture event processing according to some embodiments of the present disclosure. The apparatus 700 may be implemented as or included in the terminal device 110. The various modules/components in the apparatus 700 may be implemented by hardware, software, firmware, or any combination thereof.

As shown, the apparatus 700 includes a gesture detection module 710 configured to detect a predetermined gesture event for a presented scene. The scene includes UI element(s) and object(s) in the scene. The apparatus 700 further includes a target selection module 720 configured to select an interaction target from at least one UI element and at least one object in response to determining that the predetermined gesture event involves the at least one UI element and the at least one object. The apparatus 700 further includes a gesture response module 730 configured to cause the interaction target to respond to the predetermined gesture event without the rest of the at least one UI element and the at least one object except the interaction target responding to the predetermined gesture event.

In some embodiments, the target selection module 720 includes: a depth determination module configured to determine respective depths of the at least one UI element and the at least one object in the scene; and a depth usage module configured to select the interaction target based on the depths.

In some embodiments, the gesture response module 730 includes a function triggering module configured to trigger a function associated with a UI element in response to determining that the interaction target is the UI element of the at least one UI element.

In some embodiments, the gesture response module 730 includes an object manipulation module configured to, in response to determining that the interaction target is an object of the at least one object, cause the object to be manipulated in the scene based on the predetermined gesture event.

In some embodiments, the gesture detection module 710 is further configured to detect a further gesture event for the scene subsequent to the predetermined gesture event; and the gesture response module 730 is further configured to cause the determined interaction target to respond to the further gesture event in response to determining that the further gesture event involves the at least one UI element and the at least one object.

In some embodiments, the apparatus 700 further includes: an interaction object determining module configured to determine UI element(s) or object(s) involved by the predetermined gesture event using a ray casting algorithm based on a position of the detected predetermined gesture event in the scene.

In some embodiments, the ray casting algorithm is implemented by a ray projector associated with a virtual camera that monitors the UI element or object.

In some embodiments, the scene comprises an augmented reality scene and the object comprises an augmented reality object and a representation of a real object in a real world in the scene.

In some embodiments, the response to the predetermined gesture event is implemented using a script.

FIG. 8 illustrates a block diagram of an electronic device 800 in which one or more embodiments of the present disclosure may be implemented. It should be understood that the electronic device 800 shown in FIG. 11 is merely exemplary and should not constitute any limitation on the function and scope of the embodiments described herein. The electronic device 800 shown in FIG. 11 may be configured to implement the terminal device 110 in FIG. 1.

As shown in FIG. 8, the electronic device 800 is in the form of a general-purpose computing device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor capable of executing various processes according to a program stored in the memory 820. In a multiprocessor system, a plurality of processing units execute computer-executable instructions in parallel to improve the parallel processing capability of the electronic device 800.

The electronic device 800 typically includes a variety of computer storage media. Such media may be any available media that is accessible to electronic device 800, including, but not limited to, volatile and non-volatile media, removable and non-removable media. The memory 820 may be a volatile memory (e.g., registers, cache, random access memory (RAM)), non-volatile memory (e.g., read-only memory (ROM), electrically-erasable programmable read-only memory (EEPROM), flash memory), or some combination thereof. The storage device 830 may be a removable or non-removable medium, and may include a machine-readable medium, such as a flash drive, a magnetic disk, or any other medium, which may be capable of storing information and/or data (e.g., training data for training) and may be accessed within the electronic device 800.

The electronic device 800 may further include an additional removable/non-removable, volatile/non-volatile storage medium. Although not shown in FIG. 8, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 820 may include a computer program product 825 having one or more program modules configured to perform various methods or acts of various embodiments of the present disclosure.

The communication unit 840 communicates with another computing device by using a communication medium. Additionally, the functionality of the components of the electronic device 800 may be implemented in a single computing cluster or in multiple computing machines that are capable of communicating over a communication connection. Thus, the electronic device 800 may run in a networked environment using logical connections to one or more other servers, network personal computers (PCs), or another network node.

The input device 850 may be one or more input devices, such as a mouse, keyboard, trackball, or the like. The output device 860 may be one or more output devices, such as s display, speaker, printer, or the like. The electronic device 800 may also communicate with one or more external devices (not shown) through the communication unit 840 as needed. The external device such as a storage device, a display device, etc., communicates with one or more devices that enable a user to interact with the electronic device 800, or with any device (e.g., a network card, a modem, etc.) that enables the electronic device 800 to communicate with one or more other computing devices. The communication may be performed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product tangibly stored on a non-transitory computer readable medium is further provided. The computer program product comprises computer executable instructions which are executed by a processor to implement the method described above.

Various aspects of the disclosure are described herein with reference to the flowchart and/or block diagrams of methods, apparatuses, devices, and computer program products implemented according to the disclosure. It should be understood that each block of the flowchart and/or block diagrams and combinations of blocks in the flowchart and/or block diagrams may be implemented by computer-readable program instructions.

These computer-readable program instructions may be provided to a processing unit of a general-purpose computer, special computer, or any other programmable data processing apparatus to produce a machine that generates an apparatus to implement the functions/acts specified in the one or more blocks in the flowchart and/or block diagrams when the instructions are executed by the processing unit of the computer or the other programmable data processing apparatus. These computer-readable program instructions may also be stored in a computer-readable storage medium that causes a computer, programmable data processing apparatus, and/or any other device to function in a particular manner, such that the computer-readable medium having instructions stored thereon includes an article of manufacture including instructions that implement various aspects of the functions/acts specified in the one or more blocks in the flowchart and/or block diagrams.

The computer-readable program instructions may be loaded onto a computer, any other programmable data processing apparatus, or any other device such that a series of operational steps are performed on the computer, other programmable data processing apparatus, or other device to produce a computer-implemented process. As such, the instructions that execute on the computer, other programmable data processing apparatus, or other device implement the functions/acts specified in the one or more blocks in the flowchart and/or block diagrams.

The flowchart and block diagrams in the drawings illustrate the architecture, functionality, and operations of possible implementations of systems, methods, and computer program products according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above, and the above description is exemplary, not exhaustive, and is not limited to the disclosed implementations. Many modifications and alterations will be apparent to those of ordinary skill in the art without departing from the scope and spirit of the illustrated implementations. The selection of terms as used herein is intended to best explain the principles of various implementations, practical applications or improvements to technology in the market, or to enable those of ordinary skill in the art to understand various implementations disclosed herein.

1. A method for gesture event processing, comprising:
detecting a predetermined gesture event for a presented scene, the scene comprising a user interface element and an object of a different type than the user interface element;
in response to determining that the predetermined gesture event involves at least one user interface element and at least one object, selecting an interaction target from the at least one user interface element and the at least one object; and
causing the interaction target to respond to the predetermined gesture event without the rest of the at least one user interface element and the at least one object except the interaction target responding to the predetermined gesture event.

2. The method of claim 1, wherein selecting the interaction target from the at least one user interface element and the at least one object comprises:
determining respective depths of the at least one user interface element and the at least one object in the scene; and
selecting the interaction target based on the depths.

3. The method of claim 1, wherein causing the interaction target to respond to the predetermined gesture event comprises:
in response to determining that the interaction target is a user interface element of the at least one user interface element, triggering a function associated with the user interface element.

4. The method of claim 1, wherein causing the interaction target to respond to the predetermined gesture event comprises:
in response to determining that the interaction target is an object of the at least one object, causing the object to be manipulated in the scene based on the predetermined gesture event.

5. The method of claim 1, further comprising:
detecting a further gesture event for the scene subsequent to the predetermined gesture event; and
in response to determining that the further gesture event involves the at least one user interface element and the at least one object, causing the determined interaction target to respond to the further gesture event.

6. The method of claim 1, further comprising:
determining, based on a detected position of the predetermined gesture event in the scene, a user interface element or an object involved by the predetermined gesture event by using a ray casting algorithm.

7. The method of claim 6, wherein the ray casting algorithm is implemented by a ray projector associated with a virtual camera monitoring the user interface element or the object.

8. The method of claim 1, wherein the scene comprises an augmented reality scene and the object comprises an augmented reality object and a representation of a real object in a real world in the scene.

9. The method of claim 1, wherein the response to the predetermined gesture event is implemented with a script.

10. (canceled)

11. (canceled)

12. An electronic device, comprising:
at least one processing unit; and
at least one memory coupled to the at least one processing unit and storing instructions for execution by the at least one processing unit, the instructions, when executed by the at least one processing unit, causing the device to perform operations comprising:
detecting a predetermined gesture event for a presented scene, the scene comprising a user interface element and an object of a different type than the user interface element;
in response to determining that the predetermined gesture event involves at least one user interface element and at least one object, selecting an interaction target from the at least one user interface element and the at least one object; and
causing the interaction target to respond to the predetermined gesture event without the rest of the at least one user interface element and the at least one object except the interaction target responding to the predetermined gesture event.

13. A non-transitory computer-readable storage medium having a computer program stored thereon, the computer program being executable by a processor to implement a method comprising:
detecting a predetermined gesture event for a presented scene, the scene comprising a user interface element and an object of a different type than the user interface element;
in response to determining that the predetermined gesture event involves at least one user interface element and at least one object, selecting an interaction target from the at least one user interface element and the at least one object; and
causing the interaction target to respond to the predetermined gesture event without the rest of the at least one user interface element and the at least one object except the interaction target responding to the predetermined gesture event.

14. The electronic device of claim 12, wherein selecting the interaction target from the at least one user interface element and the at least one object comprises:
determining respective depths of the at least one user interface element and the at least one object in the scene; and
selecting the interaction target based on the depths.

15. The electronic device of claim 12, wherein causing the interaction target to respond to the predetermined gesture event comprises:
in response to determining that the interaction target is a user interface element of the at least one user interface element, triggering a function associated with the user interface element.

16. The electronic device of claim 12, wherein causing the interaction target to respond to the predetermined gesture event comprises:
in response to determining that the interaction target is an object of the at least one object, causing the object to be manipulated in the scene based on the predetermined gesture event.

17. The electronic device of claim 12, wherein the operations further comprise:
detecting a further gesture event for the scene subsequent to the predetermined gesture event; and
in response to determining that the further gesture event involves the at least one user interface element and the at least one object, causing the determined interaction target to respond to the further gesture event.

18. The electronic device of claim 12, wherein the operations further comprise:
determining, based on a detected position of the predetermined gesture event in the scene, a user interface element or an object involved by the predetermined gesture event by using a ray casting algorithm.

19. The electronic device of claim 18, wherein the ray casting algorithm is implemented by a ray projector associated with a virtual camera monitoring the user interface element or the object.

20. The electronic device of claim 12, wherein the scene comprises an augmented reality scene and the object comprises an augmented reality object and a representation of a real object in a real world in the scene.

21. The electronic device of claim 12, wherein the response to the predetermined gesture event is implemented with a script.

22. The non-transitory computer-readable storage medium of claim 13, wherein selecting the interaction target from the at least one user interface element and the at least one object comprises:
determining respective depths of the at least one user interface element and the at least one object in the scene; and
selecting the interaction target based on the depths.
